(19) United States
(12) Patent Application Publication
(10) Pub. No.: US 2006/0099359 A1
(43) Pub. Date: May 11, 2006

(54) Internally coated hollow body, coating method and device

(76) Inventor: Ludwig Hiss, Endingen (DE)

Correspondence Address: MERCHANT & GOULD PC, P.O. BOX 2903, MINNEAPOLIS, MN, 55402-0903, US

(21) Appl. No.: 10/528,637

(22) PCT Filed: Sep. 18, 2003
(86) PCT No.: PCT/EP03/10360

§ 371 Date: Sep. 16, 2005

(30) Foreign Application Priority Data
Sep. 28, 2002 (DE) 102 45 459.9
Feb. 11, 2003 (DE) 103 05 546.0

(51) Int. Cl. B28B 11/00

(52) U.S. Cl. 428/34.4

(57) ABSTRACT

The invention relates to hollow bodies, whose internal surface is coated, to a coating method and to devices for carrying out said coating method to specifically adapt the physical characteristics, e.g. electrical conductivity, diffusion behavior or the chemical stability of hollow bodies, such as for example plastic tubes or flexible hoses, by coating their internal surface using a gas plasma to a thickness of between 5 and 1000 nm. The coatings are applied individually or as a sandwich and act bi-directionally. For example said coatings protect a medium in the interior of the hollow body from contamination by the surrounding area and by the material of the wall of the hollow body itself, or protect the surrounding area from the medium with an efficiency that has not previously been achieved, for said coatings prevent the medium from escaping through the wall of the hollow body.

### TECHNICAL FIELD

This disclosure relates generally to hollow tubing or hoses, and methods and devices for making hollow tubing or hoses.

### BACKGROUND

Many industries use hollow tubing or hoses in production and manufacture of various products or output. Often, it is desirable to protect the medium contained within the hollow tubing or hose from contamination from the surrounding area or from the material that makes up the hollow tubing or hose. Other times, it is desirable to prevent contamination of the surrounding area or the material that makes up the hollow tubing or hose from the medium. Improvements to conventional tubing or hoses, and to conventional methods of manufacturing such tubing or hoses, to increase the efficiency of such prevention and protection, are needed.

### SUMMARY

In one aspect, the present invention relates to a hollow body including a tube or hose having a coated inner surface. In another aspect, the present invention relates to a method of coating an inner surface of a hollow body. And yet in another aspect, the present invention relates to a system for coating the inner surface of a hollow body.

### BRIEF DESCRIPTION OF THE DRAWINGS

FIG. 1 is a schematic representation of a system for coating the inside of a tube or hose, in accordance with the principles disclosed.

### DETAILED DESCRIPTION

The invention relates to flexible hollow bodies with a coated interior surface, coating procedures and devices for performing the coating procedure to specifically adapt the physical properties, such as electrical conductivity, diffusion behavior or chemical resistance of hollow bodies, such as plastic tubes or flexible hoses, by coating their interior surface using a gas plasma in a coating thickness of 5-1000 nm. The coatings are applied singly or as a sandwich and act bi-directionally at the coating sites. Such coatings protect for example a medium inside the hollow body from contamination from the environment or from the material of the hollow body itself, or the surroundings from the medium inside the hollow body with not-previously attained efficacy, or prevent the medium from escaping through the wall of the hollow body.

The purpose of the present invention is to protect the inside of a plastic tube more effectively than has yet been possible, for example against contamination, that is from release of substances from the plastic itself and from diffusion of substances from the environment of the tube through the wall of the tube.

Thus far the use of plastic tubes and hoses has failed to fulfill this task because of this release of plastic components and their deficient diffusion barrier against external influence for example in the foods industry (taste alteration, oxidation) or in the semiconductor industry (transport of high-purity substances in liquid or gas form).

Moreover, due to the poor leakage rates (typical helium leakage rate tube 1 m long, 100 mm outer diameter, 1 mm wall thickness: >10⁻⁴ mbar 1 s⁻¹) it was likewise not possible to transport or store substances in plastic tubes or hoses without high loss.

In order to effectively protect the inside and the environment of the plastic hoses and tubes both against the release of plastic components and influences from within and without, its inner wall is coated in a plasma process, e.g. with Si₃N₄, SiO₂ or metal oxides like WOₓ (separated for example from coating substances like SiH₄, WF₆, NH₃, N₂ and O₂).

Other properties, such as electrical conductivity inside the tube can be adjusted by coating substances such as WF₆, CH₄, PH₃, B₂H₆, TiCl₄, AlCl₃, aluminum hydride, and other metal-organic compounds, which are produced as required in a chemical reaction proceeding the plasma process.

Several layers of various compositions over one another result in simultaneous adjustment of various properties.

In the literature, processes are described (e.g. U.S. Pat. No. 4,265,276) which convert plastic material on the inner surface by means of plasma inside a plastic tube and thus protect liquids inside the tube against transfer of certain plastic components. For example, a plasma process with argon is described which acts on the inner wall of the tube at a frequency of 13.56 MHz, power of 50 watts and pressure of 1 Torr for 1 minute.

Studies performed in connection with this invention have shown, however, that plastic tubes prepared according to this description do not have improved helium leakage rates and thus do not offer any better protection against dispersion of contaminants from the tube environment than untreated tubes.

The claims of this invention are therefore inner-coated hollow bodies, tubes or hoses, whereby the coating may be single or multi-layered and preferably of Si₃N₄, SiO₂, W, WC, WSi, Al, Ti and/or Si-n, and also procedures and devices for achieving the coatings.

The claims of the invention are detailed in the description and in examples below.

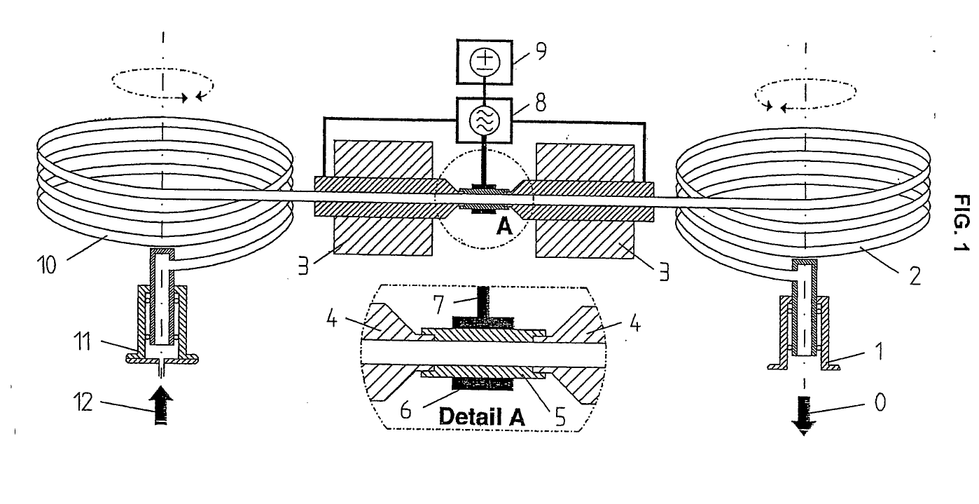

The equipment presented in FIG. 1 is used to coat the inside of plastic tubes with various materials.

The HF-source (8) is a 13.56 MHz generator, output set between 2 and 200 W coupled with a direct current voltage source (9) (adjustable primary potential at the electrodes (4,5) [+/−0 to 4000 V]). In order to enable continuous coating of longer tubes, the tube is drawn lengthwise past the ring electrode (6). The ring electrode (6) with the electrode connector (7) (connection HF source with ring electrode) is held by the electrically non-conducting electrode centering sheath (5) rotation-symmetrically on the tube calibration sheath (4). Gas inlet (12) is through a vacuum-sealed rotary transmission (11), which is connected to a tube spool (10) on the gas-inlet side. Coating pressure is set at 0.3-15 mbar, depending on the gas used, such as argon, hydrogen, nitrogen, helium, SiH₄, SiH₂Cl₂, CH₄, NH₃, WF₆, PH₃, B₂H₆, TiCl₄, AlCi₃, aluminum hydride, or other metal-organics and mixtures thereof. The symmetrically constructed ovens (3,4) with their heating elements (3) and (easily exchangeable for various tube diameters) tube calibration sheaths (4) can preheat the tube to 20-400° C. prior to entry into the plasma area and are at the same time the counter potential for the ring electrode (6). The process exhaust gases are sucked off according to the arrangement on the gas-inlet side over the tube spool (2), and the vacuum-sealed rotary transmission (1) by the vacuum pump (0) connected to the gas-outlet side.

The equipment of this invention can be used with suitable adaptation for inside coating of inflexible plastic tubes and hollow bodies which are open on one side, such as plastic beverage bottles. For hoses, the tube spools (2,10) are replaced with a linear transporter which pushes the hose past the ring electrode (6). The end of the hose is attached with flexible tubes to the gas inlet (12) and to the vacuum pump (0) attached to the gas outlet side. For beverage bottles, the gas plasma is created between the inner wall of the bottle and a hollow electrode (replaces the ring electrode shown in FIG. 1) inserted into the bottle through the one-sided bottle opening, which is connected to the gas inlet (12) to introduce the process gas. The HF-counterpotential forms a separable, conductive electrode mimicking the outer contours of the bottle. The process exhaust gases also flow through the one-sided bottle opening between the hollow electrode and the bottle connector inside wall to the vacuum pump (0) connected on the gas output side.

The layer properties achieved using the equipment of this invention described in FIG. 1 can be tested for their characteristic properties, such as diffusion density, conductivity, cracking, adhesion capacity and fatigue strength under reversed bending stresses, as described in the example below.

The plastic tubes and hoses coated under different conditions to achieve increased diffusion density are examined using the helium leakage test method. For this, the tube is sealed in a surrounding “coaxial outer tube” and connected to a leakage tester with a vacuum-sealed armature. The intermediate space between the “coaxial outer tube” and the tube surface to the tested is flooded with 1 L helium. Proof of helium is made in the tube inner space with a quantity-calibrated helium mass spectrometer. This arrangement enables testing of the helium diffusion through the tube wall of the test sample without disrupting secondary influences (such as leakage at the connecting armature).

In order to avoid ionizing properties (which may result in electrical discharges in the gas-filled tube) of non-conducting tubes/hoses for gas, various, electrically-conductive layers, such as n-doped silicon, tungsten, tungsten silicide, tungsten carbide or other conductive separable layers are used. The electrical conductivity is determined by measuring resistance by means of two test probes placed on the layer to be tested.

Cracks and peeling of layers result from different expansion coefficients and elasticity modules between the tube and hose materials and the coatings. Cracking during coating can be influenced and optimized by the coating parameters. Cracking and adhesion capacity in the finished coated tube are tested in a reverse bending stress test. For this, the tube is bent 1000 times at one level by ±900 with r=15 d (example: 10 mm outer diameter=150 mm). During the test, it was found that testing with the helium leakage test is adequate for one-layer systems, since even very fine cracks and peelings can be detected based on the increased escape rate of the helium.

In multi-layer combination systems, inspection for cracking is also made with the light and frame electronic microscope.

The invention claim is explained in more detail in the following examples.

Using the apparatus shown in FIG. 1, the inner surfaces of plastic tubes made of PTFE (polytetrafluoroethylene), PFA (perfluoroalkoxy), LD-PE (low density polyethylene), PA (polyamide), HD-PE (high density polyethylene), PU (polyurethane), PVDF (polyvinylidine fluoride), MFA (perfluoromethylalkoxy) and FEP (fluorinated ethylene propylene) with an outer/inner diameter of 10/8 mm were coated with a plasma of SiH₄, NH₃ and N₂. The frequency of the HF sources was 13.56 MHz and 27.12 MHz, their output 100 watts. A pressure of 1.7 mbar (measured at the vacuum pump outlet) was selected as the pressure inside the plastic tube; drawing speed was 1 m/min. The layer resulting from the described test was identified on the basis of its property as Si₃N₄ (silicon nitride) layer. In other gas combinations, coatings of glass, tungsten carbide, tungsten silicide, n-conductive silicon, tungsten, aluminum and titanium could be produced.

Examples of results for plastic tubes after treatment with the recommended state-of-the-art method above and invention-conforming single coating with silicon nitride (Si₃N₄), the preheating temperature used and the leakage rates attained and electrical resistances are presented in Table 1 below.

TABLE 1

| | Temperature | He-leakage rate | He-leakage rate | Electric |
|---|---|---|---|---|
| | Layer | Untreated | Treated | Resistance |
| Sample | [° C.] | [mbar 1\|s⁻¹ m⁻¹] | [mbar 1 s⁻¹ m⁻¹] | [Ω m⁻¹] |
| PTFE | 22 | 1.3 · 10⁻³ | 1.3 · 10⁻³ | ∞ |
| Argon | | | | |
| plasma | | | | |
| PTFE | 200 | 1.3 · 10⁻³ | 3.6 · 10⁻⁵ | ∞ |
| PFA | 200 | 1.0 · 10⁻³ | 1.5 · 10⁻⁵ | ∞ |
| LD-PE | 40 | 9 · 10⁻⁵ | 9 · 10⁻⁷ | ∞ |
| PA | 40 | 7 · 10⁻⁵ | 8 · 10⁻⁷ | ∞ |
| PVDF | 40 | 2 · 10⁻⁵ | 6 · 10⁻⁸ | ∞ |

The results for plastic tubes with single-coating silicon dioxide (SiO₂, glass) according to the invention, the preheating temperatures used and the leakage rates attained and electrical resistances are presented in Table 2 below.

TABLE 2

| | Temperature | He-leakage rate | He-leakage rate | Electric |
|---|---|---|---|---|
| | Layer | Untreated | Treated | Resistance |
| Sample | [° C.] | [mbar 1\|s⁻¹ m⁻¹] | [mbar 1 s⁻¹ m⁻¹] | [Ω m⁻¹] |
| PTFE | 200 | 1.3 · 10⁻³ | 1.35 · 10⁻⁴ | ∞ |
| LD-PE | 40 | 9 · 10⁻⁵ | 8.5 · 10⁻⁶ | ∞ |

The results for plastic tubes with single-coating tungsten oxide (WO) according to the invention, the preheating temperatures used and the leakage rates attained and electrical resistances are presented in Table 3 below.

TABLE 3

| | Temperature | He-leakage rate | He-leakage rate | Electric |
|---|---|---|---|---|
| | Layer | Untreated | Treated | Resistance |
| Sample | [° C.] | [mbar 1\|s⁻¹ m⁻¹] | [mbar 1 s⁻¹ m⁻¹] | [Ω m⁻¹] |
| LD-PE | 40 | 9 · 10⁻⁵ | 9 · 10⁻⁷ | ∞ |

The results for plastic tubes with single-coating tungsten according to the invention, the preheating temperatures used and the leakage rates attained and electrical resistances are presented in Table 4 below.

TABLE 4

| | Temperature | He-leakage rate | He-leakage rate | Electric |
|---|---|---|---|---|
| | Layer | Untreated | Treated | Resistance |
| Sample | [° C.] | [mbar 1\|s⁻¹ m⁻¹] | [mbar 1 s⁻¹ m⁻¹] | [Ω m⁻¹] |
| LD-PE | 50 | 9 · 10⁻⁵ | 8 · 10⁻⁷ | >10⁶ |

The results for plastic tubes with single-coating tungsten silicide (WSi) according to the invention, the preheating temperatures used and the leakage rates attained and electrical resistances are presented in Table 5 below.

TABLE 5

| | Temperature | He-leakage rate | He-leakage rate | Electric |
|---|---|---|---|---|
| | Layer | Untreated | Treated | Resistance |
| Sample | [° C.] | [mbar 1\|s⁻¹ m⁻¹] | [mbar 1 s⁻¹ m⁻¹] | [Ω m⁻¹] |
| LD-PE | 200 | 1.3 · 10⁻³ | 8 · 10⁻⁴ | <10⁵ |

The results for plastic tubes with single-coating tungsten carbide according to the invention, the preheating temperatures used and the leakage rates attained and electrical resistances are presented in Table 6 below.

TABLE 6

| | Temperature | He-leakage rate | He-leakage rate | Electric |
|---|---|---|---|---|
| | Layer | Untreated | Treated | Resistance |
| Sample | [° C.] | [mbar 1\|s⁻¹ m⁻¹] | [mbar 1 s⁻¹ m⁻¹] | [Ω m⁻¹] |
| PTFE | 200 | 1.3 · 10⁻³ | 8 · 10⁻⁵ | <10⁶ |

The results for plastic tubes with single-coating n-doped silicon (Si-n) according to the invention, the preheating temperatures used and the leakage rates attained and electrical resistances are presented in Table 7 below.

TABLE 7

| | Temperature | He-leakage rate | He-leakage rate | Electric |
|---|---|---|---|---|
| | Layer | Untreated | Treated | Resistance |
| Sample | [° C.] | [mbar 1\|s⁻¹ m⁻¹] | [mbar 1 s⁻¹ m⁻¹] | [Ω m⁻¹] |
| PTFE | 200 | 1.3 · 10⁻³ | 6 · 10⁻⁴ | <10⁵ |

Initial tests with plastic tubes coated according to this invention in the examples cited above showed a 30- to 100-fold better diffusion density for He atoms than uncoated comparison tubes and than tubes treated in the state-of-the-art discussed above with a single silicon nitride (Si₃N₄) coating.

Proof of the constant electrical conductivity after the reverse bending stress test could also be brought.

The coating thickness and its uniformity after the procedure of this invention in the tube/hose can easily be optimized by persons skilled in the art using the calibration hole in the tube calibrating sheath (4), the ring electrode (6), the electrode centering sheath (5) and other parameters, such as coating pressure temperature, HF output and gas composition. This enables the manufacture of reproducible products, which is prerequisite for industrial applications. In flexible or rigid tubes or hoses, for example, the coating thickness can be adjusted very easily by altering the drawing speed without changing all other parameters.

The test results for the present invention show that coatings with different properties can be applied to the inside of hollow bodies in a gas plasma. Depending on the material to be coated and the coating material, the diffusion density for example increases with increasing coating thickness of the applied coating and then decreases due to cracking. Analogous is also true of the electrical conductivity. The improvements shown as examples of improved leakage rate, the possibility of applying electrically-conductive coating and of adjusting the chemical resistance of tube inner surfaces attained with suitable coating material open completely new application aspects for plastic tubes and hoses. Especially combined coatings (i.e. several layers applied in sequence) e.g. plastic tube inner walls—tungsten—Si₃N₄ (silicon nitride) together increase the diffusion resistance to well above the factor cited for single layers above, are electrically conductive and have very high abrasion resistance and chemical stability.

The above specification provides a complete description of the invention. Since many embodiments of the invention can be made without departing from the spirit and scope of the invention, certain aspects of the invention reside in the claims hereinafter appended.

What is claimed is:

1. A hollow body, comprising:
a tube having a inner surface; and
a coating deposited on the inner surface of the tube.

2. The hollow body of claim 1, wherein one or more layers of the coating is deposited on the inner surface of the tube or hose.

3. The hollow body of claim 1, wherein the coating comprises of one or more of Si₃N₄, SiO₂, W, WC, WSi, Si-n, WO₃, Al, Ti and other metals or metal oxides

4. The hollow body of claim 1, wherein the tube or hose is made of plastic comprising of PTFE, PFA, LD-PE, PA, HD-PE, PU, PVDF, MFA, FEP or any type of rubber.

5. A method of manufacturing a plastic tube having an inner surface, the method comprising the steps of:
drawing the tube past a ring electrode, the ring electrode being connected to an HF source and a direct current source;
simultaneously heating the tube with a heating elements while drawing the tube past the ring electrode;
creating a vacuum at one end of the tube; and
introducing a gas into an opposite end of the tube to coat the inner surface of the plastic tube.

6. The method of claim 5, wherein the gas is argon, hydrogen, nitrogen, helium, SiH₄, SiH₂Cl₂, CH₄, NH₃, PH₃, B₂H₆, WF₆, TiCl₄, AlCl₃, aluminum hydride, or other metal-organics and mixtures thereof.

7. An arrangement for coating the inside of objects, the arrangement comprising:
a direct current source;
an HF source connected to the direct current source;
a ring electrode connected to the HF source;
an object spool located at an inlet side of the arrangement;
a vacuum apparatus located at an outlet side of the arrangement; and
and a gas inlet arranged to communicate gas to the objects for coating the inside of the objects.

8. An arrangement for coating the inside of objects having only one opening, the arrangement comprising:
a direct current source;
an HF source connected to the direct current source;
an object spool located at an inlet side of the arrangement;
a vacuum apparatus located at an outlet side of the arrangement;
a gas inlet; and
a hollow electrode connected for introduction of gas to the gas inlet.
